(19) United States
(12) Patent Application Publication
(10) Pub. No.: US 2008/0160173 A1
(43) Pub. Date: Jul. 3, 2008

(54) Component Moulding Process

(75) Inventor: Risto Ronkka, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/616,624

(22) Filed: Dec. 27, 2006

(51) Int. Cl. B05D 5/00

(52) U.S. Cl. 427/58; 439/55

(57) ABSTRACT

A method for embedding electronic components in a mold material for subsequent connection of the electronic components by printing on the surfaces of the set and cured mold material. The electronic components are placed on two UV transparent foils and are embedded into the mold material from two opposite sides.

### FIELD OF THE INVENTION

The present invention relates to a method of embedding electronic components in a mold material, in particular to a method of embedding electronic components in a mold material for subsequent connection by printing on the sides of mold material and on the embedded electronic components.

### BACKGROUND OF THE INVENTION

Printed electronics allow interconnection of electronic component with direct deposition systems such as inkjets or dispensers using nano metal inks. This interconnection method will replace the use of printed circuit boards and soldering, and it will also remove the need for wirebonding on IC packages.

In the printed electronics process there is a need to embed components inside a mold material before the printing process can take place. However, existing molding processes require high temperature and pressure to create necessary properties for the molded structure.

### DISCLOSURE OF THE INVENTION

On this background, a method is provided for embedding electronic components in a mold material that overcomes or at least reduces the drawbacks associated with the existing methods.

In this regard, a method is provided for embedding electronic components in a mold material, the method comprising placing electronic components on one side of a first substantially UV transparent foil, placing electronic components on one side of a second substantially UV transparent foil, placing the first and the second foils substantially opposite to one another with their sides with the electronic components facing one another and with a layer of UV settable mold material placed between the two substantially UV transparent foils, moving the first and second foils towards one another to press the electronic components into the layer of UV settable mold material and thereby embedding the electronic components into the UV settable mold material, and setting the UV settable mold material by exposing the layer of UV settable mold material though one or both the foils to UV light.

Thus, a method is obtained that does not require high pressures or high temperatures.

The method may further comprise removing the first and second foils. The removal of the foils can be done after setting or after curing.

The method may also comprise curing the blank by heating the blank.

The method may further comprise electrically connecting the electronic components by printing connections on the surface of the blank.

The method may also comprise exposing both sides of the blank to UV light. Thus, the mold material can be set faster.

The layer of UV curable mold material can be placed on one of the substantially UV transparent foils before the substantially UV transparent foils are moved towards one another.

The layer of UV settable material can be surrounded by a flexible dam. Thus, it is possible to use a mold material with a lower viscosity, which renders it easier to embed the electronic components therein.

The flexible dam can be formed by a bead or strip of a UV settable material with a viscosity greater than the viscosity of the UV settable mold material. The flexible dam can also be formed by a silicone based material.

The UV settable material and/or the UV settable mold material can be epoxy based materials.

The method can be performed under vacuum or substantially reduced pressure to facilitate the removal of any trapped air bubbles in the mold material.

It is yet another object of the present invention to provide an electronic module comprising a molded material with electronic components embedded in the molded material on both sides of the article, the electronic components being electrically connected by print on both sides of the article.

Further objects, features, advantages and properties of the method and article according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIGS. 1 to 4 are cross-sectional views illustrating the method of embedding electronic components according to an embodiment of the invention, and

FIG. 5 is a top view illustrating the state as in FIG. 3 by a top view.

### DETAILED DESCRIPTION OF PREFERRED EMBODIMENTS

In the following detailed description, the method and article according to the invention will be described by the preferred embodiments.

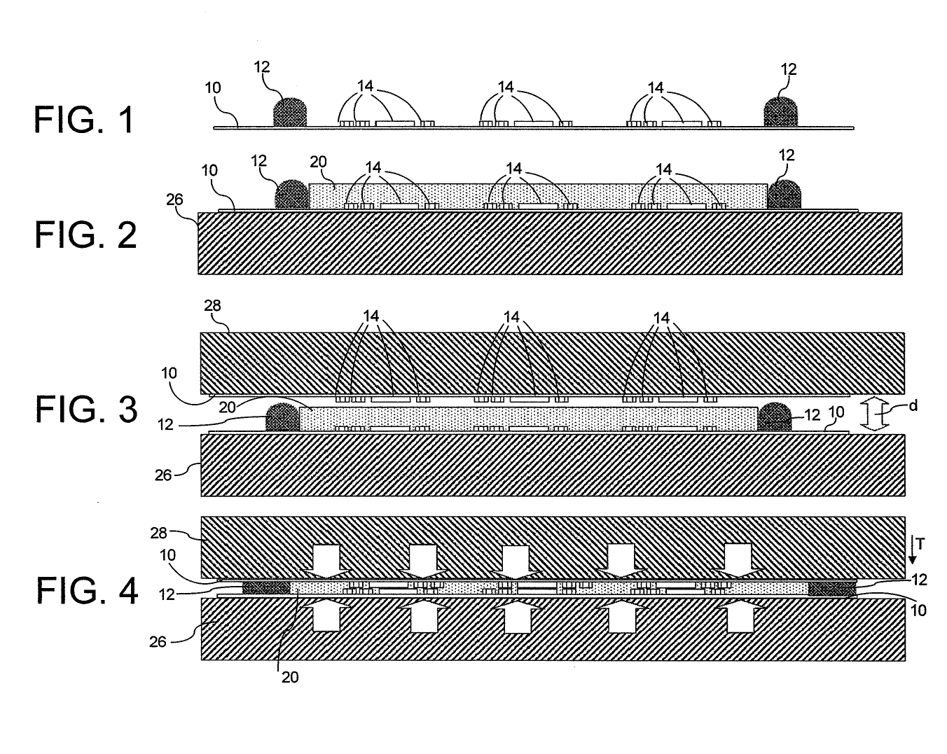

FIGS. 1 to 4 illustrate step by step an embodiment of the method according to the invention by cross-sectional views. FIG. 4 is a top view illustrating the state as in FIG. 3 by a top view.

At the start of the method two pieces of UV transparent foil 10 are on one of their sides provided with electronic components 14. The electronic components 14 can be conventional IC components as they are used on conventional printed circuit boards. Specific electronic components 14 are placed in accordance with the predetermined design of the electronic device/circuit that is to be realized.

At least one of the UV transparent foils 10 is provided with a dam that can be formed by any suitable elastic or plastic material. According to the present embodiment the dam is formed by a bead 12 of UV settable polymer or resin-based material with a relatively high viscosity. The dam can be formed of other material, such as for example a silicone based material.

A layer of UV settable mold material 20 is placed over the electronic components 14 on the UV transparent foil 10 that is provided with the bead 12. The molding material 20 has preferably a low viscosity to facilitate the embedding of the electronic components 14. The molding material 20 can in an embodiment be a resin or polymer-based UV settable material. The UV transparent foil with the bead 12 and the UV settable molten material 20 is placed on a mold halve or table 26.

The other UV transparent foil 10 is attached to another mold halve or table 28. The two mold halves or tables 26 and 28 are positioned with the UV transparent foils 10 opposite to one another with their side electronic components 14 facing one another, cf. FIG. 3. The UV transparent foils 10 are at this stage of the method separated by a given distance indicated by arrow d.

In the next step of the method according to the present embodiment, which is illustrated in FIG. 4, the mold halves or tables 26 and 28 are moved towards one another to press the electronic components 14 into the UV settable mold material 20, thereby embedding the electronic components 14 into the mold material 20. In the shown embodiment, mold halve 26 is static, whereas mold halve 28 is moved in the direction of arrow T until the foils are spaced apart by an exact right predetermined distance.

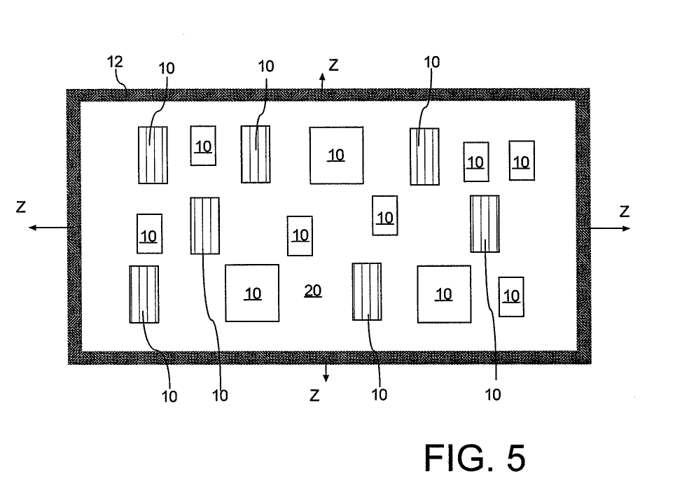

As shown in FIG. 5, the beads 12 move outwards in the direction of arrows Z during the molding process. The dam does not need to enclose the mold material completely as shown in the drawings. The main function of the dam is to ensure that the foils 10 do not get into contact with one another, and therefore the dam can have interruptions (not shown).

When the electronic components 14 have been properly embedded into the mold material 20 (the molding process can be performed under vacuum or under a low pressure environment to facilitate the removal of air bubbles trapped in the molding material 20) the mold material 20 is exposed to UV light from UV light sources in the mold halves 26 and 28. The UV light exposure is symbolized by the thick arrows in FIG. 4. According to another embodiment (not shown) the mold material is first removed from the mold halves 26,28 and set elsewhere by exposing the mold material 20 to UV light.

The blank with set mold material is then removed from the mold and placed in an oven for curing (not shown).

When the mold material 20 is cured the UV transparent foils 10 are peeled from the blank (this step can also be done directly after setting). The blank is cleaned and thereafter the surfaces of the blank are printed (with inkjet or dispensers using nano metal ink to create an electrically conductive print) in accordance with a predetermined pattern to establish the electrical connections between the electrical components 14.

When the electronic connections are printed the blank is transformed to an electronic module.

The material of the dam 12 is also set by the UV light and cured in the oven. Optionally, the material of the dam 12 can be cut off.

According to an embodiment (not shown) a metal foil can be added between the two layers of electronic components, i.e. the metal foil is embedded in the mold material. In this embodiment RF components can be placed on one side of the metal foil and other sensitive electronic components on the other side of the foil, to avoid RF waves interfering with the operation of the RF sensitive components.

The invention has numerous advantages. Different embodiments or implementations may yield one or more of the following advantages. It should be noted that this is not an exhaustive list and there may be other advantages which are not described herein. One advantage of the invention is that it allows for embedding electronic components without applying high pressures or high temperatures. Another advantage of the invention is that it allows the production of a compact and reliable flat article with embedded electronic components. It is another advantage of the invention that the symmetrical component placement on both sides prevents warping/bending of the module in curing due the differences of material properties and shrinkage. It is a further advantage of the invention that the electrical properties can be improved by positioning RF components on one side and other sensitive components on the other side of a metal foil that is embedded in the mold material between the layers of electronic components. It is yet another advantage of the invention that the electrical properties will be improved due to reduced distances therebetween. Also height differences of components can be accommodated on both sides. It is a further advantage of the invention that the size of the system can be reduced with optimized placement of the components to thereby reduce the amount of molding material that is needed. It is yet another advantage of the invention that optical components can be embedded in the mold material due the transparent nature of the UV transparent mold material.

The term “comprising” as used in the claims does not exclude other elements or steps. The term “a” or “an” as used in the claims does not exclude a plurality

Although the present invention has been described in detail for purpose of illustration, it is understood that such detail is solely for that purpose, and variations can be made therein by those skilled in the art without departing from the scope of the invention.

1. A method for embedding electronic components in a mold material, the method comprising:
placing electronic components on one side of a first substantially UV transparent foil,
placing electronic components on one side of a second substantially UV transparent foil,
placing the first and the second foils substantially opposite to one another with their sides with the electronic components facing one another and with a layer of UV settable mold material placed between the two substantially UV transparent foils,
moving the first and second foils towards one another to press the electronic components into the layer of UV settable mold material and thereby embedding the electronic components into the UV settable mold material, and
setting the UV settable mold material by exposing the layer of UV settable mold material though one or both the foils to UV light.

2. A method according to claim 1, further comprising removing the first and second foils.

3. A method according to claim 1, further comprising curing a blank comprised of the UV settable mold material and the embedded electronic components by heating the blank.

4. A method according to claim 2, further comprising electrically connecting the electronic components by printing connections on the surface of a blank comprised of the UV settable mold material and the embedded electronic components.

5. A method according to claim 1, further comprising exposing both sides of a blank comprised of the UV settable mold material and the embedded electronic components to UV light.

6. A method according to claim 1, wherein the layer of UV curable mold material is placed on one of the substantially UV transparent foils before the substantially UV transparent foils are moved towards one another.

7. A method according to claim 1, wherein the layer of UV settable material is surrounded by a continuous or interrupted flexible or viscous dam.

8. A method according to claim 7, wherein the flexible or viscous dam is formed by a bead or strip of a UV settable material with a viscosity greater than the viscosity of the UV settable mold material.

9. A method according to claim 1, wherein the UV settable material and/or the UV settable mold material are epoxy or polymer based materials.

10. A method according to claim 1, performed under vacuum or substantially reduced pressure.

11. An electronic module comprising a molded material with electronic components embedded in the molded material on both sides of the electronic module, the electronic components being electrically connected by print on both sides of the electronic module.
